(19) United States
(12) Patent Application Publication
(10) Pub. No.: US 2017/0273512 A1
(43) Pub. Date: Sep. 28, 2017

(54) Underlay Strip

(71) Applicant: Horst Christian Raffalt, Vienna (AT)

(72) Inventor: Horst Christian Raffalt, Vienna (AT)

(21) Appl. No.: 15/512,366

(22) PCT Filed: Sep. 18, 2015
(86) PCT No.: PCT/EP2015/071451

§ 371 Date: Mar. 17, 2017

(30) Foreign Application Priority Data
Sep. 19, 2014 (AT) A711/2014

(51) Int. Cl. A47J 47/00

(52) U.S. Cl. CPC A47J 47/005

(57) ABSTRACT

The invention relates to an underlay strip consisting of silicon and having a top side and a substantially planar underside, the top side of the underlay strip having at least two raised supporting surfaces.

The invention relates to support strips, which, under a base, for example a cutting board, provide for slip resistance, stability, sanitation, and a better work area.

Today, wet dishcloths, Wettex sponge cloths, or thin anti-slip floor mats are put down, which make it possible for bacteria and germs to settle in joints and crevices. This runs counter to sanitation instructions and complicates sanitation management.

In addition, these known supports lie flat and have only a support surface with hardly any stability or slip resistance while working.

Other drawbacks are that the known supports are not resistant to chemicals and temperatures over 100 degrees, and their mechanical strength will not stand up to cleaning in a dishwasher. They must be disposed of after repeated use.

These known supports have no stiffness whatsoever to allow them to be placed in the dishwasher basket in a stable manner.

In addition, these known thin supports provide almost no elevation for the cutting board and do not make it easy to tilt the cutting board, in particular when wet. Thus, the cutting boards lie around wet for hours.

Also, curved cutting boards are only used on one side since, when turned over, the cutting board only has one point of support and rocks during cutting and thus offers no occupational safety.

In addition, no hard blows, for example with a meat tenderizer, can be performed on the cutting board, since it provides no damping behavior.

The invention is accordingly based on the object of making available a support for cutting boards, which does not have the above-mentioned drawbacks. The support is to make the cutting board slip-resistant, to stabilize it, and to provide for a safe operation (cutting, cracking, hammering, etc.), as well as to offer the possibility of using cutting boards that are curved on both sides. The object of the invention is also to support and to use in a time-efficient manner the legal sanitation regulations in industrial operations, such as commercial kitchens.

In addition, an object of the invention is to make possible an agreeable, ergonomic working height as well as to compensate for non-flat or uneven cutting boards. Another object of the invention is to make it easy to lift/tilt the cutting board when changing it.

These and other objects are achieved according to the invention by a support strip that is made of silicone with a top and an essentially flat bottom, whereby the support strip has at least two elevated support surfaces on the top.

According to the invention, it can be provided that the support surfaces in each case have a raised profile on the top of the support strip.

According to the invention, it can be provided that the support strip has a trapezoidal cross-section, whose base forms the bottom of the support strip.

According to the invention, it can be provided that recessed profiles, which are designed essentially minor-inverted to the raised profiles on the top, are provided on the bottom of the support strip.

The use of food-safe silicone allows a simple and sanitary cleaning of the support strips, as well as flexibility with regard to adapting to irregular bases and cutting boards. Because of the trapezoidal cross-section, the essentially flat bottom, and the profile on the top, it is achieved that the support strip adheres in a stable manner to the base and does not slip.

The two elevated support surfaces on the top allow stable positioning and at the same time ventilation of the cutting board. The profiles on the top of the support surfaces in turn provide for the cutting board to be held in position in a stable manner and not to slip.

According to the invention, it can be provided that the raised profile on the top and the recessed profile on the bottom are designed in such a way that when two support strips are stacked on top of one another, the raised profile of the first support strip can be snugly engaged in the recessed profile of the second support strip. As a result, it is achieved that when the support strips are stacked on top of one another, the latter do not slip and the cutting board is supported in a stable manner.

According to the invention, it can be provided that the raised profile on the top and/or the mirror-inverted recessed profile on the bottom is/are designed in the form of laterally open concentric circles or in the form of a laterally open spiral.

As a result, it is achieved that moisture found on the base or on the bottom of the cutting board optionally is forced outward by the laterally open circles or the spiral, and no moisture cushion can form under the support strip that would cause the support strip or the cutting board to slip.

According to the invention, it can be provided that the thickness of the support strip in the area of the elevated support surfaces is more than 8 mm, preferably 9 mm to 14 mm, and the thickness of the support strip in the area outside of the elevated support surfaces is less than 8 mm, preferably 5 mm to 7 mm. These thicknesses have in practice proven especially advantageous.

According to the invention, it can be provided that the support strip has a trapezoidal cross-section, and the longitudinal side of the support strip forms an angle of 60° to 80°, preferably 70°, with the bottom of the support strip.

According to the invention, it can be provided that at least one longitudinal edge of the support strip in the area of the bottom has a reinforcement that increases the stiffness. As a result, it is achieved that a longitudinal edge of the support strip can also be used for wiping off moisture or scraps. In addition, the stability in the case of stationary positioning, for example in a dishwasher, is thus increased.

According to the invention, it can be provided that the cross-section of the support strip is designed in the shape of a circular segment, a semi-circle, a semi-circle with a flat area that runs parallel to the flat bottom, a semi-oval with a flat area that runs parallel to the flat bottom, or in the shape of a polygon.

According to the invention, it can be provided that a longitudinal edge of the support strip has a curved edge in the area of the top and/or in the area of the bottom. As a result, it is achieved that in these edge areas, the support strip does not develop any cracks or fractures after extended exposure to stress. Such cracks or fractures in the edge areas would make it possible for germs to settle in, by which a sanitary use would be made difficult.

According to the invention, it can be provided that the support strip comprises silicone with a hardness in the range of 20 Shore A to 90 Shore A, preferably 55 Shore A to 65 Shore A, especially preferably 60 Shore A. The silicone can be a special silicone that is suitable for use with constant food contact.

In particular, the support strip can comprise food-safe silicone of the Series R 401 with a tensile strength according to DIN 53504-S1 of 6.4 MPa, an elongation at break according to DIN 53504-S1 of 400%, a hardness according to DIN 53505 of 51 Shore A, a tear resistance according to ASTM D624B of 10 N/mm, a density according to DIN 53479 of 1.13 g/cm3, as well as a compressive strain resistance according to DIN 53517 of 3%.

The invention further extends to a system that consists of multiple support strips according to the invention, whereby the support strips have varying thicknesses with regard to adapting to the desired working height or damping. According to the invention, it is provided to use at least two support strips for such a system.

According to the invention, it can be provided that the support strips of such a system have varying hardnesses with regard to adapting to the desired damping.

According to the invention, it can also be provided that the support strips are designed for meeting the requirements of the HAACP [Hazard Analysis and Critical Control Point] design and the EU food sanitation regulation. In particular, the support strips can be dyed various colors, for example red for red meat, yellow for poultry, blue for raw fish, green for salad and fruit, white for pastries and dairy products, as well as brown or orange for vegetables, in order to facilitate a sanitary use for the user.

The invention further extends to the use of multiple support strips according to the invention, whereby the support strips can be stacked on top of one another arbitrarily.

The invention is now further explained with reference to an embodiment, which is diagrammatically depicted in the drawings.

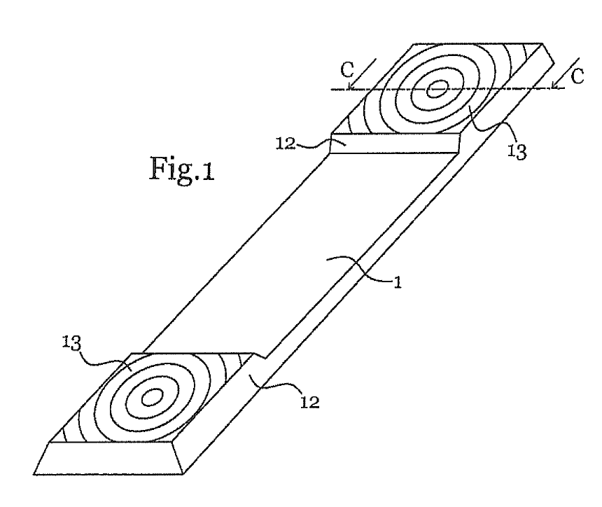

FIG. 1 shows the top of the support strip I according to the invention with the elevated support surfaces 12 and the profile 13.

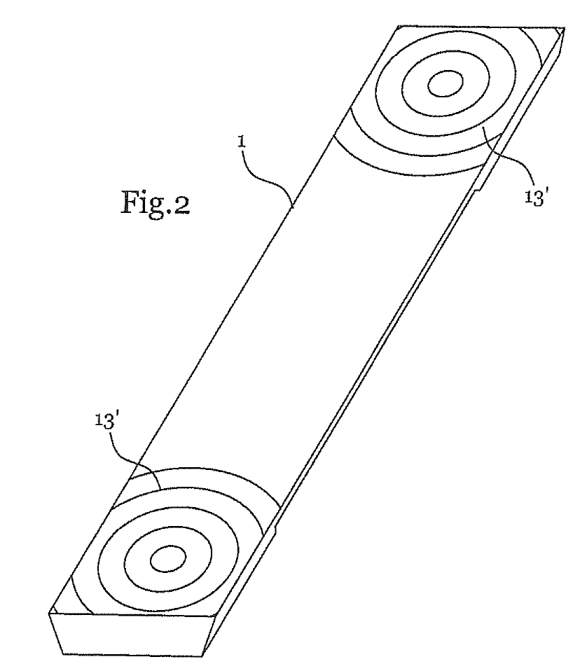

FIG. 2 shows the bottom with the mirror-inverted profile 13′.

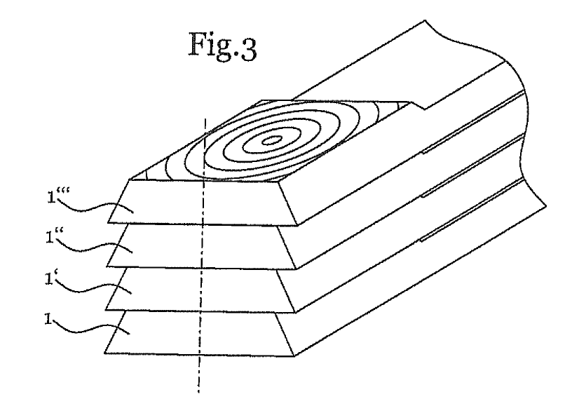

FIG. 3 shows four support strips 1 that are stacked on top of one another for elevation or storage.

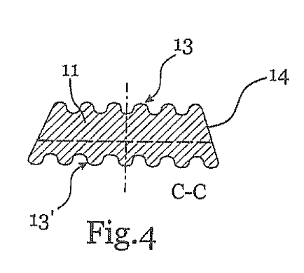

FIG. 4 shows the trapezoidal cross-section 11 with the mirror-inverted profiles 13 and 13′.

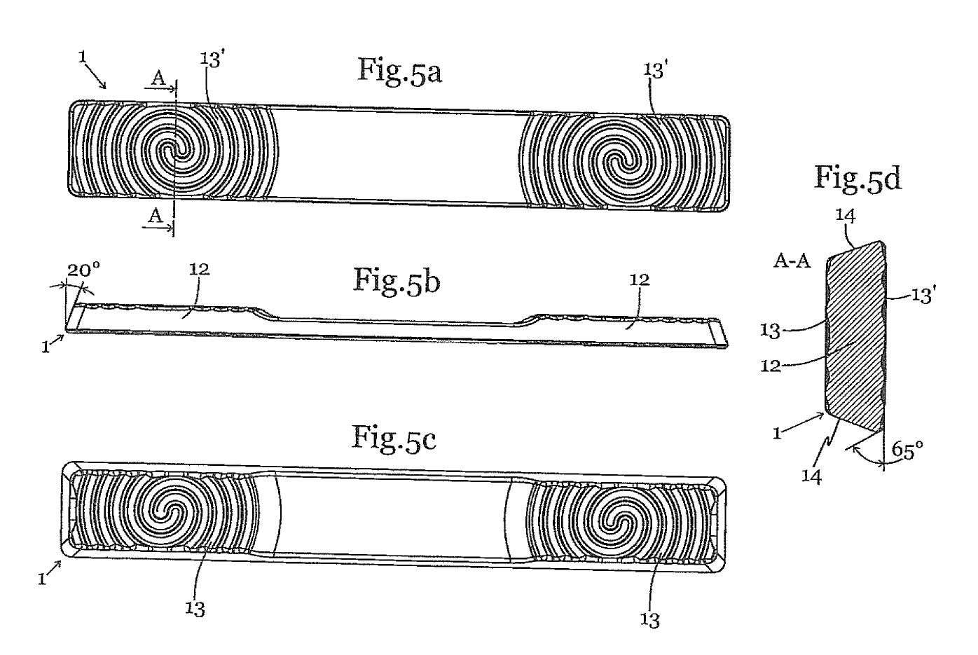

FIGS. 5a-5d show another embodiment of a support strip according to the invention.

The support strip 1 has a rectangular shape and a trapezoidal cross-section 11. The support strip 1 is cast of silicone, in one piece without joints and crevices, which ensures slip resistance, temperature resistance, chemical resistance, and food safety. Dirt does not gain a foothold, and it is easy to clean by hand.

The damping behavior can be varied by stacking the support strip 1.

On the top of the support strip 1, there are two elevated support surfaces 12, with a raised profile 13 in each case.

The profile 13 is designed in the form of projections that are concentric, open on the side edges, or circular or spiral in shape.

The bottom of the support strip 1 is provided with a mirror-inverted profile 13′. This profile 13′ is designed in the form of grooves that are concentric, open on the side edges, or circular or spiral in shape. During stacking of multiple support strips 1, the mirror-inverted profiles 13, 13′ engage in one another. This results in a stable stacking during elevation of the cutting board by stacking the support strips on top of one another as well as in a variation of the damping behavior.

In the case of two applied support strips 1, the two elevated support surfaces 12 provide four support surfaces on which a curved cutting board, with a downward curvature, can also be applied and used. The cutting board does not lie around wet for hours but rather is ventilated.

The profiles 13 on the top and the mirror-inverted profiles 13′ on the bottom improve the adhesion in the case of wet conditions and make possible stable stacking.

A material thickness of at least five millimeters produces sufficient clearance height for quick and easy lifting of the cutting board.

The Shore hardness of the silicone further ensures sufficient stiffness for secure placement in the washer.

Because of the trapezoidal cross-section 11 and the Shore hardness of the silicone, the support strip 1 is stiff enough to use the support strip 1 even for wiping processes. To this end, the support strip 1 is picked up lengthwise at the top edge between thumb and forefinger and, e.g., scraps/wetness are removed from the table. In addition, hard blows/noises on the support material are damped by the support strip 1.

FIG. 3 shows a diagrammatic depiction of a system that consists of four support strips 1, 1′, 1″, 1′″ that are stacked on top of one another. The profiles on the bottoms in this case engage respectively in the profiles on the tops of the subjacent support strips, so that the four support strips are snugly connected. The support strips 1, 1′, 1″, 1′″ can be distinguished in their damping and in their thickness so that a user can select a desired working height and the desired damping property (hard, medium, soft) by selecting the stacked support strips.

FIG. 4 shows a cross-section through a support strip I with a trapezoidal cross-section 11. The profile 13 on the top is mirror-inverted to the profile 13′ on the bottom, so that the projections on the top can be brought into a snug connection with corresponding grooves on the bottom. The longitudinal side 14 forms an angle of approximately 70° on the bottom.

In addition, in the depicted embodiment, both the longitudinal edges in the area of the top and the longitudinal edges in the area of the bottom have curved edges, by which the occurrence of fractures or cracks on the edges, which would facilitate the settling of germs, is avoided.

FIGS. 5a-5d show another embodiment of the support strip according to the invention. FIG. 5a shows a view of the bottom, FIG. 5b shows a view of the side, FIG. 5c shows a view of the top, and FIG. 5d shows a sectional view. The raised profile and the recessed profile are designed as mirror-inverted spirals in this embodiment.

1. A support strip that is made of silicone with a top and an essentially flat bottom, wherein the support strip has at least two elevated support surfaces on the top.

2. The support strip as claimed in claim 1, wherein the support surfaces in each case have a raised profile.

3. The support strip as claimed in claim 1, wherein the support strip has a trapezoidal cross-section, whose base forms the bottom of the support strip.

4. The support strip as claimed in claim 1, wherein recessed profiles, which are made essentially mirror-inverted to the raised profiles, are provided on the bottom.

5. The support strip as claimed in claim 1, wherein the raised profile on the top and the recessed profile on the bottom are designed mirror-inverted in such a way that when two support strips are stacked on top of one another, the raised profile of the first support strip can be snugly engaged in the recessed profile of the second support strip.

6. The support strip as claimed in claim 1, wherein the raised profile and/or the mirror-inverted recessed profile is/are designed in the form of laterally open concentric circles or in the form of a laterally open spiral.

7. The support strip as claimed in claim 1, wherein the thickness of the support strip in the area of the elevated support surfaces is more than 8 mm, preferably 9 mm to 14 mm, and the thickness of the support strip in the area outside of the elevated support surfaces is less than 8 mm, preferably 5 mm to 7 mm.

8. The support strip as claimed in claim 1, wherein the longitudinal side of the support strip forms an angle of 60° to 80° , preferably 70° , with the bottom of the support strip.

9. The support strip as claimed in claim 1, wherein the longitudinal edge of the support strip in the area of the bottom has a reinforcement that increases the stiffness.

10. The support strip as claimed in claim 1, wherein the cross-section of the support strip is designed in the shape of a circular segment, a semi-circle, a semi-circle with a flat area that runs parallel to the flat bottom, a semi-oval with a flat area that runs parallel to the flat bottom, or in the shape of a polygon.

11. The support strip as claimed in claim 1, wherein the longitudinal edge of the support strip has a curved edge in the area of the top and/or in the area of the bottom.

12. The support strip as claimed in claim 1, wherein the support strip comprises silicone with a hardness in the range of 20 Shore A to 90 Shore A, preferably 60 Shore A.

13. A system that comprises multiple support strips as claimed in claim 1, wherein the support strips have varying thicknesses.

14. A system that comprises multiple support strips as claimed in claim 1, wherein the support strips have varying hardnesses with regard to adapting to the damping.

15. Use of multiple support strips as claimed in claim 1, whereby the support strips can be stacked on top of one another arbitrarily.
